(19) United States
(12) Patent Application Publication
(10) Pub. No.: US 2001/0032715 A1
(43) Pub. Date: Oct. 25, 2001

(54) Method of manufacturing combination heat-sink and heat-sink made thereby

(75) Inventor: Kuo-Chung Peng, Hsinchu City (CN)

Correspondence Address: Ladas & Parry, 26 West 61st Street, New York, NY, 10023, US

(73) Assignee: NEW CENTURY TECHNOLOGY CO., LTD.

(21) Appl. No.: 09/837,949

(22) Filed: Apr. 19, 2001

(30) Foreign Application Priority Data
Apr. 21, 2000 (TW) 089107589

(51) Int. Cl. F28F 7/00; B23K 31/02

(52) U.S. Cl. 165/80.3; 228/183

(57) ABSTRACT

The present invention discloses a method of manufacturing a combination heat sink having a best heat transfer efficiency and a combination heat sink made thereby. The present method comprises steps (a) to (d). In step (a), the plurality of radiating fins are piled up by sparing the radiating fins apart from each other in a substantially parallel manner with the bottom edges thereof being oriented in a same direction. In step (b), a recess is formed on the top surface of the common surface. In step (c), a heat-conductive brazing alloy is applied to the recess of the common surface. In step (d), the plurality of radiating fins are joined with the common base by seating the bottom edges of the fins onto the recess of the common base and heating the brazing alloy.

### BACKGROUND OF THE INVENTION

1. Field of the Invention

This invention relates to a method of manufacturing a heat sink and a heat sink made thereby, and particularly to a method of manufacturing a combination heat sink with any material and shape and a combination heat sink made thereby.

2. Description of the Prior Art

In line with the development of computers and technology, a heat sink for radiating heat resulting tom CPU becomes important and tiny. Moreover, in line with the upgrade of the CPU, the heat volume generated by the CPU also becomes larger, and thus heat-radiating effect for the CPU is more stressed.

In general, a heat sink for CPU comprises a base to contact with the CPU and with a plurality of fins perpendicularly positioned on i. Based on the product shape, size, and material to be formed, The manufacturing methods of heat sink can be classified as mechanic cutting, pressing, casting, and powder metallurgy sintering. For small size heat sink which made by aluminum pressing method is cheaper than that made by the other method. However, for larger size heat sink, the casting method is ever used but with the disadvantages in throughput and quality control. Therefore, for the larger size heat sink, an adapted method has been developed. Firstly, fin bodies were framed and then combining the fin bodies together by rivets or screws to form a complete heat sink which is called a combination heat sink.

However, in the process of riveting and assembling the fin bodies, a process of providing the fin bodies with holes and a process of pass the rivets through the fin bodies are necessary. Such processes make the assembly complicated &id expensive. Moreover, since the fin bodies are combined together by means of rivets, they cannot provide good heat conduction due to bud contact among them. As a result, the heat conduction effect of heat sink declines. This phenomenon becomes a drawback for the heat sink made of copper, which is not available lay means of pressing.

### SUMMARY OF THE INVENTION

An object of this invention is to provide a method of manufacturing a combination heat sink ha a best heat transfer efficiency and a combination heat sink made thereby.

To achieve the above object, the present invention discloses a method of manufacturing a combination heat sink. The present method comprises steps (a) to (d). In step (a), the plurality of radiating fins are piled up by spacing the radiating fins apart from each other in a substantially parallel manner with the bottom edged thereof being oriented in a, same direction, In step (b), a recess is formed on the top surface of the common surface. In step (c), a heat-conductive brazing alloy is applied to the recess of the common surface. In step (d), the plurality of radiating fins a joined with the common base by seating the bottom edges of the fins onto the recess of the common base and heating the brazing alloy.

By means of the above procedures, each of the radiating fins is brazed to the common base by heat-conductive brazing alloy, a combination heat sink having a good heat transfer efficiency is complete.

Moreover, the common base can be formed by powder metallurgy sintering process so as to decrease manufacturing cost. The sintering process and the brazing alloy heating process arc performed in vacuum so as to reduce the influence of the oxidation on heat conduction efficiency.

The advantages and features of this invention can be easily understood through the drawings and detailed explanations.

### BRIEF DESCRIPTION OF THE DRAWINGS

FIG. 1 is a perspective view illustrating the radiating fins and the common base of this invention.

FIG. 2 is a perspective view illustrating the groove of the common base being coated with a layer of heat conductive brazing alloy.

FIG. 3 is a perspective view illustrating a completed heat sink manufactured by the method of this invention.

FIG. 4 is a perspective view illustrating another one completed heat sink manufactured by the method of this invention.

### DETAILED DESCRIPTION OF EMBODIMENTS

Speaking of a combination heat sink, there are two kinds of methods. One is forming a plenty of radiating fin bodies firs, then laminating and combining all of the radiating fin bodies together by means of coupling method. The other is firstly farming a plenty of radiating fins and a common base and lien combing die radiating fins and the common base together. This invention belongs to the latter one.

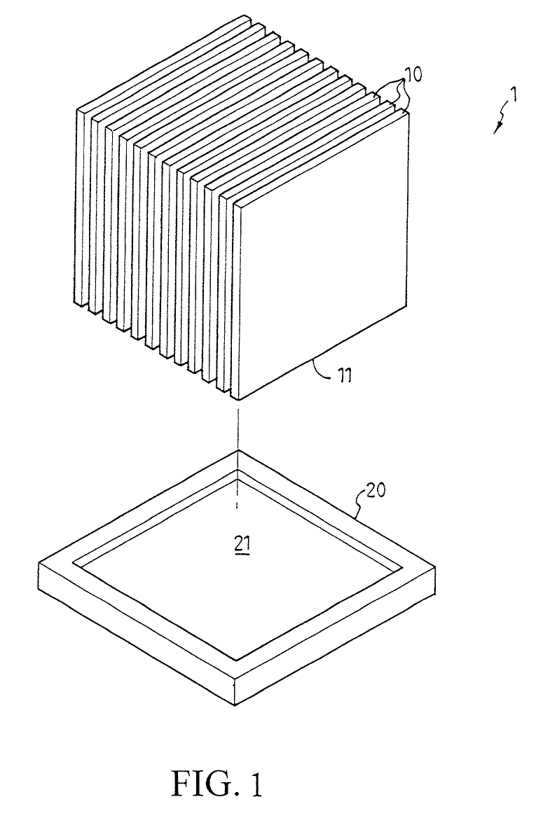

FIG. 1 shows a plenty of radiating fins 10 and a common base 20 formed in accordance with a first step of the method according to a first embodiment of this invention.

As shown in FIG. 1, each of the radiating fins 10 is of a quadrilateral plate having a bottom edge 11 to be seated on the common base 20. The common base 20 is of a thicker quadrilateral plate having a common groove 21 formed on the upper surface thereof. The groove 21 has a longitudinal width substantially identical to that of each radiating fin 10 and the lateral length of groove 21 is wide enough to receive all of the radiating fins 10 in spacing. Each of the radiating fins 10 and the common base 20 can be made of copper or album , which is formed by pressing or cutting, The common base 20 can be made by a suitable method such as powder metallurgy sintering or casting. The groove 21 on the common base 20 can be formed by pressing.

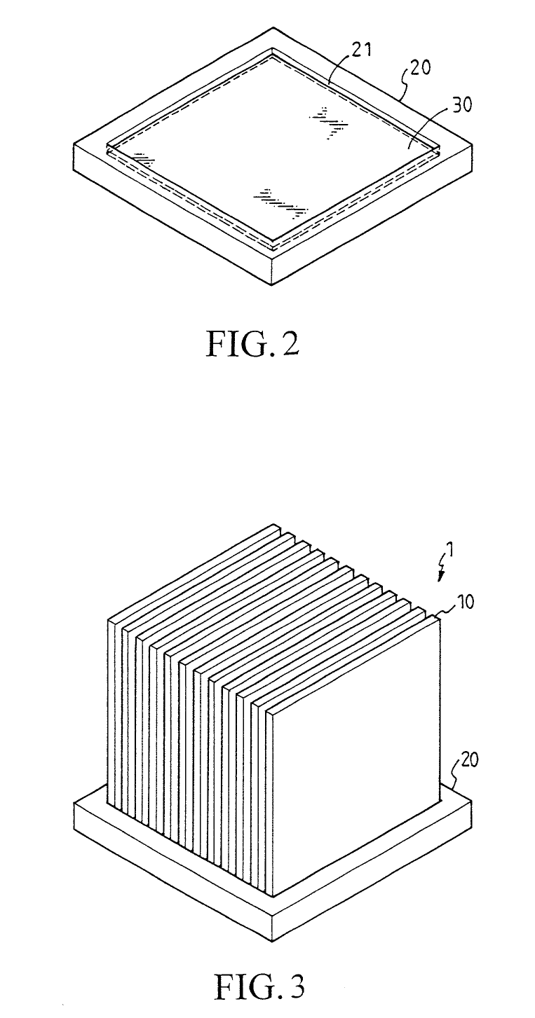

FIG. 2 is a perspective view showing the common base 20 which has been coated or putted with a layer of heat-conductive brazing alloy 30 on the groove 21 thereof. Such coating step is performed before seating all of the radiating fins on the common base 20. The brazing alloy 30 can be of any heat-conductive brazing alloy and preferably a silver-based or copper base brazing alloy. The brazing alloy 30 can be a sheet form for being easily put on the groove 21, or in a paste form to be coated on the groove 21 by spraying or platting.

After coating or putting the brazing alloy 30 on the grove 21, each bottom edge of the radiating fins 10 is seated on the groove 21 in spacing. Meanwhile, using a holding tool (not shown) to fix all the radiating fins 10 in parallel spacing.

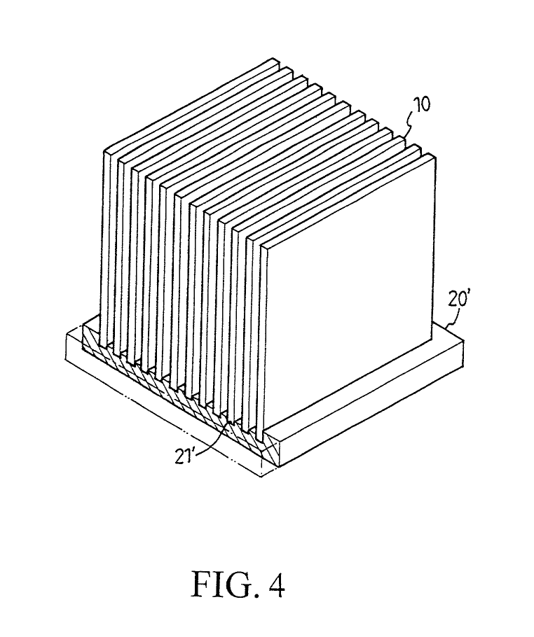

Subsequently, the common base 20 with the radiating fins 10, brazing alloy 30, and the holding tool on it is heated to brazed each of the radiating fins 10 onto the common base 20. The heating process is performed in vauum condition or protective gas atmosphere (N₂ or Ar) to reduce the formation of oxidation. FIG. 3 shows a completed heat ink in which the radiating fins 10 and the common base 20 are combined together.

FIG. 4 shows another one heat sine manufactured by the method of the present invention. All the manufacturing process is same with the first one shown in FIG. 3, except the shape of the common base 20′ is different. The common bas 20′ is formed with a plenty of parallel grooves 21′ on the surface. The dimension of each groove 21′ corresponds to each one radiating fin 10, and the brazing alloy is coated on each of the grooves 21′.

By means of this invention, the radiating fins and tic common base are combined together by heat-conductive brazing alloy rather than by rivets, the manufacturing processes arc simple and the contact between the radiating fins and the common base is very good. Therefore, the heat conduction efficiency of this invention is better than others. Especially, the above method is suitable for cooper heat sink, which is difficult to be made by pressing.

While the present invention is described by way of preferred embodiments it should be understood that the embodiments are used only to illustrate the technical concept of the present invention without limiting the scope thereof. Therefore, all modifications and alterations that are readily apparent to those skilled in the art shall fall within the scope of this invention as defined in the appended claims.

What is claimed is:

1. A method of manufacturing a combination heat sink, in which the combination heat sink hag a plurality of radiating fins and a common base, each of the radiating fins having a bottom edge and the common base having a top surface, the method comprising the step of:
a) piling up the plurality of radiating fins by spacing the radiating fins apart from each other in a substantially parallel manner with the bottom edges thereof being oriented in a same direction;
b) forming a recess on the top surface of the common surface;
c) applying a heat-conductive brazing alloy to the recess of the common surface; and
d) joining the plurality of radiating fins with the common base by seating the bottom edges of the fins onto the recess of the common base and heating the brazing alloy.

2. The method as claimed in claim 1, wherein in the step d), the brazing alloy is heated in a vacuum circumstance or protective gas atmosphere.

3. The method as claimed in claim 1, wherein in the step b), a silver-based, copper base brazing alloy and solder are applied to the recess of the common base.

4. Tho method as claimed in claim 1, wherein in the step b), a sheet-shaped or paste brazing alloy is applied to the recess of thc common base.

5. A method of manufacturing a combination heat sink, in which the combination heat sink has a plurality of radiating fins and a common base, each of the radiating fins having a bottom edge and the common base having a top surface, the method comprising the step of:
a) piling up the plurality of radiating fins by spacing the radiating fins apart from each other in a substantially parallel manner with the bottom edges thereof being oriented in a same direction;
c) applying a heat-conductive brazing alloy to the grooves of the common surface; and
d) joining the plurality of radiating fins with the common base by respectively seating the bottom edges of the fins onto the grooves of the common base and hearing the brazing alloy.

6. The method as claimed in claim 5, wherein in the step d), the brazing alloy is heated in a vacuum circumstance or protective gas atmosphere.

7. The method as claimed in claim 5, wherein in step b), a silver-based copper base brazing alloy and solder are aplied to the grooves of the common base.

8. The method as claimed in claim 5, wherein in the step b), a sheet-shaped or paste brazing alloy is applied to the top surface of the common base on which the grooves are formed.

9. A combination heat sink, comprising:
a common base, having a top surface;
a plurality of radiating fins, each having a bottom edge, and
heat-conductive brazing alloy;
wherein:
the plurality of radiating fins are spaced apart from each other in a substantially parallel manner with the bottom edges thereof being oriented in a same direction, and the plurality of radiating fins are brazed onto the top surface of the common surface by the heat-conductive brazing alloy.

10. The combination heat sink as claimed in claim 9, wherein the common base is formed with a recess on the top surface thereof on which the bottom edges of the radiating fins are seated.

11. The combination heat sink as claimed in claim 9, wherein the common base is formed with a plurality of grooves on the top surface thereof on which the bottom edges of the radiating fins are respectively sealed.
